(19) United States
(12) Patent Application Publication
(10) Pub. No.: US 2017/0272728 A1
(43) Pub. Date: Sep. 21, 2017

(54) SYSTEM AND METHOD OF THREE-DIMENSIONAL SCANNING FOR CUSTOMIZING FOOTWEAR

(71) Applicant: AQUIFI, INC., Palo Alto, CA (US)

(72) Inventors: Abbas Rafii, Palo Alto, CA (US); Jackson Masters, Redwood City, CA (US); Aryan Hazeghi, Palo Alto, CA (US); Nicholas Moore, Menlo Park, CA (US); Jeremie Bourrut, Sunnyvale, CA (US)

(21) Appl. No.: 15/461,315

(22) Filed: Mar. 16, 2017

Related U.S. Application Data
(60) Provisional application No. 62/309,323, filed on Mar. 16, 2016.
(60) Provisional application No. 62/457,573, filed on Feb. 10, 2017.

(51) Int. Cl. H04N 13/02; G06Q 30/06; G05B 19/4099; G06F 17/50

(52) U.S. Cl. CPC H04N 13/0275; H04N 13/0246; H04N 13/0257; H04N 13/0296; H04N 13/0271; H04N 13/0239; G06F 17/5009; G06Q 30/0631; G05B 19/4099; G05B 2219/49023

(57) ABSTRACT

A method for generating shoe recommendations includes: capturing, by a scanning system, a plurality of depth maps of a foot, the depth maps corresponding to different views of the foot; generating, by a processor, a 3D model of the foot from the plurality of depth maps; computing, by the processor, one or more measurements from the 3D model of the foot; computing, by the processor, one or more shoe parameters based on the one or more measurements; computing, by the processor, a shoe recommendation based on the one or more shoe parameters; and outputting, by the processor, the shoe recommendation

### CROSS-REFERENCE TO RELATED APPLICATION(S)

This application claims the benefit of U.S. Provisional Patent Application No. 62/309,323 “3D Scanning for Designing Custom Shoes,” filed in the United States Patent and Trademark Office on Mar. 16, 2016; and U.S. Provisional Patent Application No. 62/457,573, “A Foot Scanning Apparatus,” filed in the United States Patent and Trademark Office on Feb. 10, 2017, the entire disclosures of which are incorporated herein by reference.

### FIELD

Aspects of embodiments of the present invention relate to the field of three-dimensional scanning, and in particular, the application of three-dimensional scanning to the customization of footwear.

### BACKGROUND

The proper sizing of footwear for a pair of feet is long standing problem. Shoes are typically sold in a variety of sizes, which may be sized by length and width. The Brannock Device® is one common tool used in brick and mortar shoe stores for sizing feet, but fails to measure some aspects of the foot such as foot volume (e.g., the height of the arch and the height of the instep) and pressure distribution.

Light bar scanners such as the Easy Foot Scan from Ortho Baltic of Kaunas, Lithuania, and arrays of gauge pins such as described in the foot contour digitizer described in U.S. Pat. Nos. 5,689,446 and 5,941,835 are also available to provide more detailed measurements of feet that are not captured by the Brannock Device®. These additional measurements allow further customization of footwear, such as for designing customized insoles or customized shoes. However, these more advanced systems are generally require expensive equipment, and may be slow to operate or may require significant training for operators to obtain accurate and useful measurements, thereby putting customized footwear out of reach of many consumers.

### SUMMARY

Aspects of embodiments of the present invention are directed to systems and methods for capturing three-dimensional scans, such as three-dimensional scans of feet and shoes. Aspects of embodiments of the present invention are also directed to systems and methods for automatically designing shoes, or portions of shoes, based on the three-dimensional scans, and for making the shoes, or portions thereof, based on the design.

According to one embodiment of the present invention, a method for generating shoe recommendations includes: capturing, by a scanning system, a plurality of depth maps of a foot, the depth maps corresponding to different views of the foot; generating, by a processor, a 3D model of the foot from the plurality of depth maps; computing, by the processor, one or more measurements from the 3D model of the foot; computing, by the processor, one or more shoe parameters based on the one or more measurements; computing, by the processor, a shoe recommendation based on the one or more shoe parameters; and outputting, by the processor, the shoe recommendation.

The one or more measurements may include a length of the foot, a width of the foot, and a height of an instep of foot.

The one or more measurements may include a measurement of a degree of pronation or supination of the foot.

The shoe recommendation may include a model and a size of a shoe.

The shoe recommendation may include a design for a component of a shoe, and the computing the one or more shoe parameters may include computing parameters for the design of the component of the shoe based on the one or more measurements.

The method may further include transmitting the design for the component of the shoe for fabrication.

The fabrication may be 3D printing.

The component of the shoe may be an outsole.

The method may further include capturing, by the scanning system, a plurality of depth maps of a worn-out shoe, the depth maps corresponding to different views of the worn-out shoe; generating, by the processor, a 3D model of the worn-out shoe from the plurality of depth maps; and identifying, by the processor, wear patterns from the 3D model of the worn-out shoe, wherein the computing the shoe recommendation is further based on the wear patterns from the 3D model of the worn-out shoe.

The scanning system may include: a scanning sensor including a first two-dimensional (2D) camera having a first optical axis and a second 2D camera having a second optical axis substantially parallel to the first optical axis, the scanning sensor being configured to capture 2D images; a display module separate from the scanning sensor and in communication with the scanning sensor; and a host processor configured to control the scanning sensor and to display user feedback on the display module, the user feedback being based on the 2D images captured by the scanning sensor.

The scanning system may include: an enclosure having a base; a transparent platform in the enclosure, the transparent platform being parallel to the base; a plurality of depth cameras in the enclosure, the depth cameras having fields of view directed toward the enclosure, each of the depth cameras including a plurality of 2D cameras; and a central processing unit configured to control the depth cameras.

The scanning system may further include a plurality of color cameras.

The depth cameras may be registered to a common reference frame.

The capturing the plurality of depth maps of the foot may include capturing images while the foot is moving.

According to one embodiment of the present invention, a system for generating shoe recommendations includes: a scanning system; a processor coupled to the scanning system; a memory coupled to the processor and having instructions stored therein that, when executed by the processor, cause the processor to: control the scanning system to capture a plurality of depth maps of a foot, the depth maps corresponding to different views of the foot; generate a 3D model of the foot from the plurality of depth maps; compute one or more measurements from the 3D model of the foot; compute one or more shoe parameters based on the one or more measurements; compute a shoe recommendation based on the one or more shoe parameters; and output the shoe recommendation.

The shoe recommendation may include a design for a component of a shoe, and the instructions that cause the processor to compute the one or more shoe parameters may further include instructions that cause the processor to compute parameters for the design of the component of the shoe based on the one or more measurements.

The memory may further store instructions that, when executed by the processor, cause the processor to transmit the design for the component of the shoe for fabrication.

The memory may further store instructions that, when executed by the processor, cause the processor to: control the scanning system to capture a plurality of depth maps of a worn-out shoe, the depth maps corresponding to different views of the worn-out shoe; generate a 3D model of the worn-out shoe from the plurality of depth maps; and identify wear patterns from the 3D model of the worn-out shoe, wherein the memory further stores instructions that, when executed by the processor, cause the processor to compute the shoe recommendation further based on the wear patterns from the 3D model of the worn-out shoe.

The instructions that, when executed by the processor, cause the processor to capture the plurality of depth maps of the foot may further include instructions that, when executed by the processor, cause the processor to control the scanning system to capture images while the foot is moving.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a block diagram of a scanning system as a stereo depth camera system according to one embodiment of the present invention, and may be applicable to both handheld scanning systems and an apparatus with multiple fixed cameras configured to scan an object.

FIG. 2A is a schematic view of a process, according to one embodiment of the present invention, for scanning a foot.

FIGS. 2B and 2C are a cut away side view and a cut away back view of a foot scanning apparatus according to one embodiment of the present invention.

FIG. 3 depicts eight different views of a single 3D model of a foot as scanned by a 3D scanning system according to one embodiment of the present invention.

FIGS. 4A and 4B depicts views from FIG. 3 with the addition of contour lines.

FIG. 5 depicts six views of a single 3D model of a worn shoe, where the model is captured according to embodiments of the present invention.

FIGS. 6A, 6B, and 6C are examples of different wear patterns of a shoe.

FIG. 6D is an illustration of a back portion of a right shoe in which the lateral (right) portion of the heel of the outsole is worn significantly more than the medial (left) portion.

FIG. 7 is a flowchart illustrating a method for scanning and analyzing a 3D scan of a foot according to one embodiment of the present invention.

FIGS. 8A, 8B, and 8C depict exemplary insole or under-sole constructions of a shoe respectively reflecting normal wear, over-pronation, and supination or under-pronation automatically designed according to one embodiment of the present invention.

FIG. 8D depicts an example of an outsole for custom shoes automatically customized based on 3D scans of feet and based on the wear patterns of worn-out shoes, as captured in the 3D scan of the worn-out shoe, according to embodiments of the present invention.

FIG. 9 is a flowchart illustrating a method for designing custom shoes based on a 3D scan of a user's conditions according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Through recent developments in three-dimensional (3D) scanning and 3D printing technologies, clothing and other wearables such as shoes, helmets, gloves, eyeglasses, and the like can be customized and tailored much more easily to particular users and their individual body shapes.

The proper fitting of shoe sizes is important to foot and posture health to general population and, in particular, athletes. Furthermore, in view of the trend increased number of sales online, ordering a shoe that fits perfectly to the customers' feet without even trying it on is highly desirable. For example, based on measurements obtained from a 3D model of a customer's feet, a seller of footwear can determine an appropriate product for the customer, including front and back width, length, height, heel, sole, backstay, lining thickness, etc.

Obtaining accurate measurements of feet also opens up additional sales opportunities for shoe manufacturers to produce custom shoes, perhaps using 3D printers. For example, 3D printing technology can be used to print custom shoes or shoe components, such as the structure of the vamp, lining, heel, insole, and outsole, which are customized or tailored to the customer, in accordance with the 3D scans of the customer's feet. Additionally, a sufficiently precise 3D model of the feet enables custom-fitted shoes to be designed and produced for individuals for various medical or athletic benefits.

Existing techniques for customizing shoes relies on a general shoe design database, measurements taken at rest (e.g., with the customer standing still on a Brannock Device® or on a line scanning system), dynamic measurements (e.g., video data of the customer walking), and the customer's preferences (e.g., comfort, style, ankle support, and lining thickness). However, capturing the information using a line scanning system generally involves expensive, specialized equipment, and analyzing video of a customer walking requires manual analysis and specialized knowledge (e.g., analysis by a podiatrist). Furthermore, using the detailed measurements and diagnosis from the specialist to design a customize shoe may be a time consuming, manual process.

As such, aspects of embodiments of the present invention are directed to systems and methods for capturing three-dimensional scans, such as three-dimensional scans of feet and shoes. Aspects of embodiments of the present invention are also directed to systems and methods for automatically designing shoes, or portions of shoes, based on the three-dimensional scans, and for making the shoes, or portions thereof, based on the design. The term “shoe” will be used herein to generally refer to footwear, and may include a variety of types of footwear, including dress shoes, casual shoes, sneakers, boots, specialized athletic shoes (e.g., for running shoes, biking shoes, golf shoes, and cleats for field sports), and specialized footwear such as ski boots, snowboard boots, and ice skates.

Embodiments of the present invention may provide low-cost system and method for performing a 3D scan of a foot to capture its measurements. Embodiments of the present invention may also provide systems and methods for performing a 3D scan of a worn (or worn-out) pair of shoes from the customer. The resulting 3D model of the worn-out pair of shoes can be analyzed to determine the wear pattern of the sole, which provides rich information about how the customer actually uses the shoes (e.g., how the customer walks, jogs, or runs). Each shoe may be scanned separately.

In some embodiments, the 3D scan of the foot and the 3D scan of the worn-out shoe are used together to design a customized pair of shoes to suit the user's particular needs, whether for comfort or for building in corrective features. For example, detecting excessive wear in one part of the worn-out shoe may indicate a problem with improper pronation, and therefore a customized shoe may be automatically designed to provide additional support or thickness in particular parts of the outsole in order to correct the user's posture while walking or running.

### Depth Camera Scanning Systems

Aspects of embodiments of the present invention use a three-dimensional (3D) scanning system that uses one or more cameras to collect data from different views of an object, such as a foot or a shoe. The 3D model is a numerical representation of the entire surface or a portion of a surface of the real-world object.

Among the camera types used for scanning, one can use an ordinary color camera, a depth (or range) camera or a combination of depth and color camera. The latter is typically called RGB-D where RGB stands for the color image and D stands for the depth image (where each pixel encodes the depth (or distance) information of the scene.) The depth image can be obtained by different methods including geometric or electronic methods. Examples of geometric methods include passive or active stereo camera systems and structured light camera systems. Examples of electronic methods to capture depth image include Time of Flight (TOF), or general scanning or fixed LIDAR cameras.

Some embodiments of the present invention are directed to hand-held 3D scanners. Other embodiments of the present invention may be directed to an apparatus including multiple cameras arranged at different locations (e.g., fixed locations) and orientations for scanning an object such as a foot (or a pair of feet) or a shoe (or a pair of shoes). This apparatus will be described in more detail below.

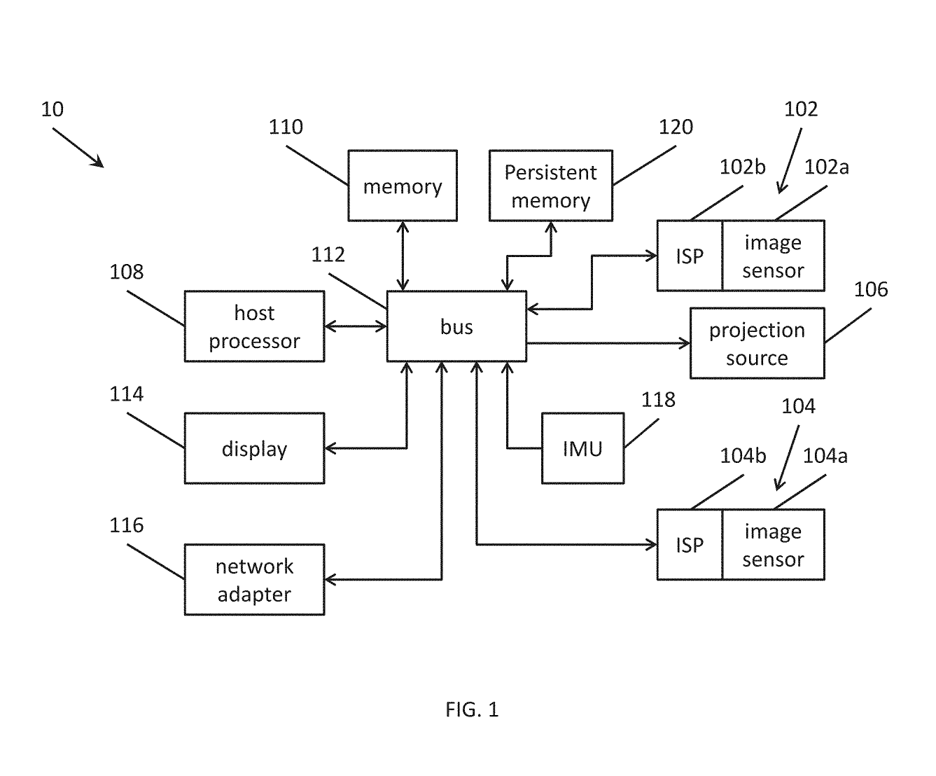

FIG. 1 is a block diagram of a scanning system as a stereo depth camera system according to one embodiment of the present invention, and may be applicable to both handheld scanning systems and an apparatus with multiple fixed cameras configured to scan an object.

The scanning system 10 shown in FIG. 1 includes a first camera 102, a second camera 104, a projection source 106 (or illumination source or active projection system), and a host processor 108 and memory 110, wherein the host processor may be, for example, a graphics processing unit (GPU), a more general purpose processor (CPU) such as an ARM or x86 architecture processor, an appropriately configured field programmable gate array (FPGA), or an application specific integrated circuit (ASIC). The first camera 102 and the second camera 104 may be rigidly attached, e.g., on a frame, such that their relative positions and orientations are substantially fixed. The first camera 102 and the second camera 104 may be referred to together as a “depth camera.” The first camera 102 and the second camera 104 include corresponding image sensors 102a and 104a, and may also include corresponding image signal processors (ISP) 102b and 104b. The various components may communicate with one another over a system bus 112. The scanning system 10 may include a network adapter 116 to communicate with other devices, a display 114 to allow the device to display images to a user, and persistent memory 120 such as NAND flash memory for storing data collected and processed by the scanning system 10.

In embodiments where the scanning system 10 is a handheld device, it may further include additional components such as an inertial measurement unit (IMU) 118 such as a gyroscope to detect acceleration of the scanning system 10 (e.g., detecting the direction of gravity to determine orientation and detecting movements to detect position changes). The IMU 118 may be of the type commonly found in many modern smartphones. The image capture system may also include other communication components, such as a universal serial bus (USB) interface controller.

In embodiments where the scanning system 10 is an apparatus with multiple cameras in fixed locations, there may be more than two cameras.

In some embodiments, the image sensors 102a and 104a of the cameras 102 and 104 are RGB-IR image sensors. Image sensors that are capable of detecting visible light (e.g., red-green-blue, or RGB) and invisible light (e.g., infrared or IR) information may be, for example, charged coupled device (CCD) or complementary metal oxide semiconductor (CMOS) sensors. Generally, a conventional RGB camera sensor includes pixels arranged in a “Bayer layout” or “RGBG layout,” which is 50% green, 25% red, and 25% blue. Band pass filters (or “micro filters”) are placed in front of individual photodiodes (e.g., between the photodiode and the optics associated with the camera) for each of the green, red, and blue wavelengths in accordance with the Bayer layout. Generally, a conventional RGB camera sensor also includes an infrared (IR) filter or IR cut-off filter (formed, e.g., as part of the lens or as a coating on the entire image sensor chip) which further blocks signals in an IR portion of electromagnetic spectrum.

An RGB-IR sensor is substantially similar to a conventional RGB sensor, but may include different color filters. For example, in an RGB-IR sensor, one of the green filters in every group of four photodiodes is replaced with an IR band-pass filter (or micro filter) to create a layout that is 25% green, 25% red, 25% blue, and 25% infrared, where the infrared pixels are intermingled among the visible light pixels. In addition, the IR cut-off filter may be omitted from the RGB-IR sensor, the IR cut-off filter may be located only over the pixels that detect red, green, and blue light, or the IR filter can be designed to pass visible light as well as light in a particular wavelength interval (e.g., 840-860 nm). An image sensor capable of capturing light in multiple portions or bands or spectral bands of the electromagnetic spectrum (e.g., red, blue, green, and infrared light) will be referred to herein as a “multi-channel” image sensor.

In some embodiments of the present invention, the image sensors 102a and 104a are conventional visible light sensors. In some embodiments of the present invention, the system includes one or more visible light cameras (e.g., RGB cameras) and, separately, one or more invisible light cameras (e.g., infrared cameras, where an IR band-pass filter is located across all over the pixels).

Generally speaking, a stereoscopic depth camera system includes at least two cameras that are spaced apart from each other and rigidly mounted to a shared structure such as a rigid frame. The cameras are oriented in substantially the same direction (e.g., the optical axes of the cameras may be substantially parallel) and have overlapping fields of view. These individual cameras can be implemented using, for example, a complementary metal oxide semiconductor (CMOS) or a charge coupled device (CCD) image sensor with an optical system (e.g., including one or more lenses) configured to direct or focus light onto the image sensor. The optical system can determine the field of view of the camera, e.g., based on whether the optical system is implements a “wide angle” lens, a “telephoto” lens, or something in between.

In the following discussion, the image acquisition system of the depth camera system may be referred to as having at least two cameras, which may be referred to as a “master” camera and one or more “slave” cameras. Generally speaking, the estimated depth or disparity maps computed from the point of view of the master camera, but any of the cameras may be used as the master camera. As used herein, terms such as master/slave, left/right, above/below, first/second, and CAM1/CAM2 are used interchangeably unless noted. In other words, any one of the cameras may be master or a slave camera, and considerations for a camera on a left side with respect to a camera on its right may also apply, by symmetry, in the other direction. In addition, while the considerations presented below may be valid for various numbers of cameras, for the sake of convenience, they will generally be described in the context of a system that includes two cameras. For example, a depth camera system may include three cameras. In such systems, two of the cameras may be invisible light (infrared) cameras and the third camera may be a visible light (e.g., a red/blue/green color camera) camera. The third camera may be optically registered (e.g., calibrated) with the first and second cameras. One example of a depth camera system including three cameras is described in U.S. patent application Ser. No. 15/147,879 “Depth Perceptive Trinocular Camera System” filed in the United States Patent and Trademark Office on May 5, 2016, the entire disclosure of which is incorporated by reference herein.

To detect the depth of a feature in a scene imaged by the cameras, the depth camera system determines the pixel location of the feature in each of the images captured by the cameras. The distance between the features in the two images is referred to as the disparity, which is inversely related to the distance or depth of the object. (This is the effect when comparing how much an object “shifts” when viewing the object with one eye at a time—the size of the shift depends on how far the object is from the viewer's eyes, where closer objects make a larger shift and farther objects make a smaller shift and objects in the distance may have little to no detectable shift.) Techniques for computing depth using disparity are described, for example, in R. Szeliski. “Computer Vision: Algorithms and Applications”, Springer, 2010 pp. 467 et seq.

The magnitude of the disparity between the master and slave cameras depends on physical characteristics of the depth camera system, such as the pixel resolution of cameras, distance between the cameras and the fields of view of the cameras. Therefore, to generate accurate depth measurements, the depth camera system (or depth perceptive depth camera system) is calibrated based on these physical characteristics.

In some depth camera systems, the cameras may be arranged such that horizontal rows of the pixels of the image sensors of the cameras are substantially parallel. Image rectification techniques can be used to accommodate distortions to the images due to the shapes of the lenses of the cameras and variations of the orientations of the cameras.

In more detail, camera calibration information can provide information to rectify input images so that epipolar lines of the equivalent camera system are aligned with the scanlines of the rectified image. In such a case, a 3D point in the scene projects onto the same scanline index in the master and in the slave image. Let uₘ and uₛ be the coordinates on the scanline of the image of the same 3D point p in the master and slave equivalent cameras, respectively, where in each camera these coordinates refer to an axis system centered at the principal point (the intersection of the optical axis with the focal plane) and with horizontal axis parallel to the scanlines of the rectified image. The difference uₛ−uₘ is called disparity and denoted by d; it is inversely proportional to the orthogonal distance of the 3D point with respect to the rectified cameras (that is, the length of the orthogonal projection of the point onto the optical axis of either camera).

Stereoscopic algorithms exploit this property of the disparity. These algorithms achieve 3D reconstruction by matching points (or features) detected in the left and right views, which is equivalent to estimating disparities. Block matching (BM) is a commonly used stereoscopic algorithm. Given a pixel in the master camera image, the algorithm computes the costs to match this pixel to any other pixel in the slave camera image. This cost function is defined as the dissimilarity between the image content within a small window surrounding the pixel in the master image and the pixel in the slave image. The optimal disparity at point is finally estimated as the argument of the minimum matching cost. This procedure is commonly addressed as Winner-Takes-All (WTA). These techniques are described in more detail, for example, in R. Szeliski. “Computer Vision: Algorithms and Applications”, Springer, 2010. Since stereo algorithms like BM rely on appearance similarity, disparity computation becomes challenging if more than one pixel in the slave image have the same local appearance, as all of these pixels may be similar to the same pixel in the master image, resulting in ambiguous disparity estimation. A typical situation in which this may occur is when visualizing a scene with constant brightness, such as a flat wall.

Methods exist that provide additional illumination by projecting a pattern that is designed to improve or optimize the performance of block matching algorithm that can capture small 3D details such as the one described in U.S. Pat. No. 9,392,262 “System and Method for 3D Reconstruction Using Multiple Multi-Channel Cameras,” issued on Jul. 12, 2016, the entire disclosure of which is incorporated herein by reference. Another approach projects a pattern that is purely used to provide a texture to the scene and particularly improve the depth estimation of texture-less regions by disambiguating portions of the scene that would otherwise appear the same.

The projection source 106 according to embodiments of the present invention may be configured to emit visible light (e.g., light within the spectrum visible to humans and/or other animals) or invisible light (e.g., infrared light) toward the scene imaged by the cameras 102 and 104. In other words, the projection source may have an optical axis substantially parallel to the optical axes of the cameras 102 and 104 and may be configured to emit light in the direction of the fields of view of the cameras 102 and 104. An invisible light projection source may be better suited to for situations where the subjects are people (such as in a videoconferencing system) because invisible light would not interfere with the subject's ability to see, whereas a visible light projection source may shine uncomfortably into the subject's eyes or may undesirably affect the experience by adding patterns to the scene. Examples of systems that include invisible light projection sources are described, for example, in U.S. patent application Ser. No. 14/788,078 “Systems and Methods for Multi-Channel Imaging Based on Multiple Exposure Settings,” filed in the United States Patent and Trademark Office on Jun. 30, 2015, the entire disclosure of which is herein incorporated by reference.

Active projection sources can also be classified as projecting static patterns, e.g., patterns that do not change over time, and dynamic patterns, e.g., patterns that do change over time. In both cases, one aspect of the pattern is the illumination level of the projected pattern. This may be relevant because it can influence the depth dynamic range of the depth camera system. For example, if the optical illumination is at a high level, then depth measurements can be made of distant objects (e.g., to overcome the diminishing of the optical illumination over the distance to the object, by a factor proportional to the inverse square of the distance) and under bright ambient light conditions. However, a high optical illumination level may cause saturation of parts of the scene that are close-up. On the other hand, a low optical illumination level can allow the measurement of close objects, but not distant objects.

In some circumstances, a stereo camera system according to one embodiment of the present invention includes two components: a detachable scanning component and a display component. In some embodiments, the display component is a computer system, such as a smartphone, a tablet, a personal digital assistant, or other similar systems. Scanning systems using separable scanning and display components are described in more detail in, for example, U.S. patent application Ser. No. 15/382,210 “3D Scanning Apparatus Including Scanning Sensor Detachable from Screen” filed in the United States Patent and Trademark Office on Dec. 16, 2016, the entire disclosure of which is incorporated by reference.

Although embodiments of the present invention are described herein with respect to stereo depth camera systems or range cameras, embodiments of the present invention are not limited thereto and may also be used with other depth camera systems that cane estimate depth from one or more views, such as time of flight cameras and LIDAR cameras.

Depending on the choice of camera, different techniques may be used to generate the 3D model. For example, Dense Tracking and Mapping in Real Time (DTAM) uses color cues for scanning and Simultaneous Localization and Mapping (SLAM) uses depth data (or a combination of depth and color data) to generate the 3D model. In the case of a handheld scanning system, a user may freely move the camera around the object (e.g., a foot or a shoe) and may capture hundreds of images (or frames) of all sides of the object to construct the 3D model.

### Scanning Feet

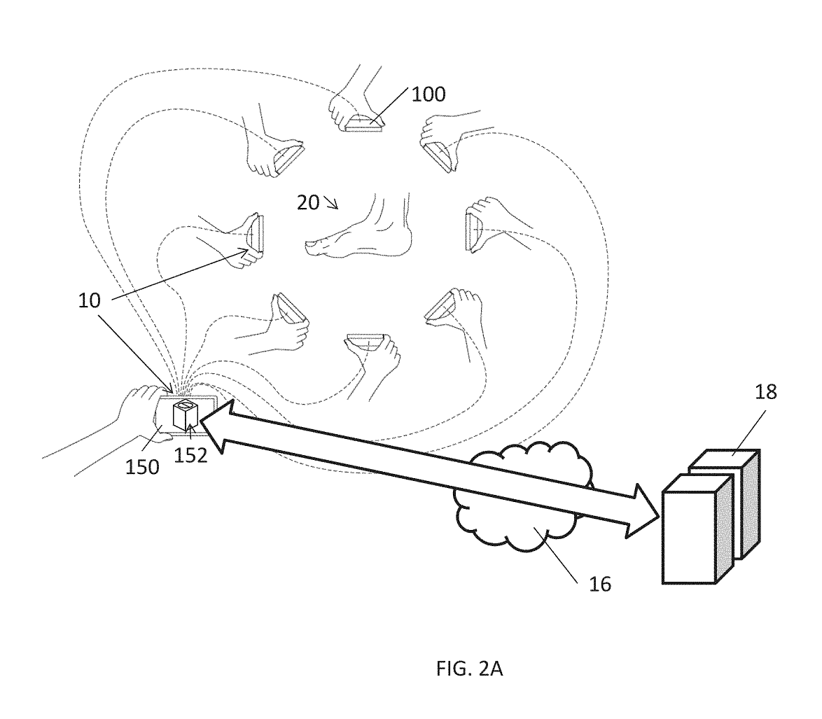

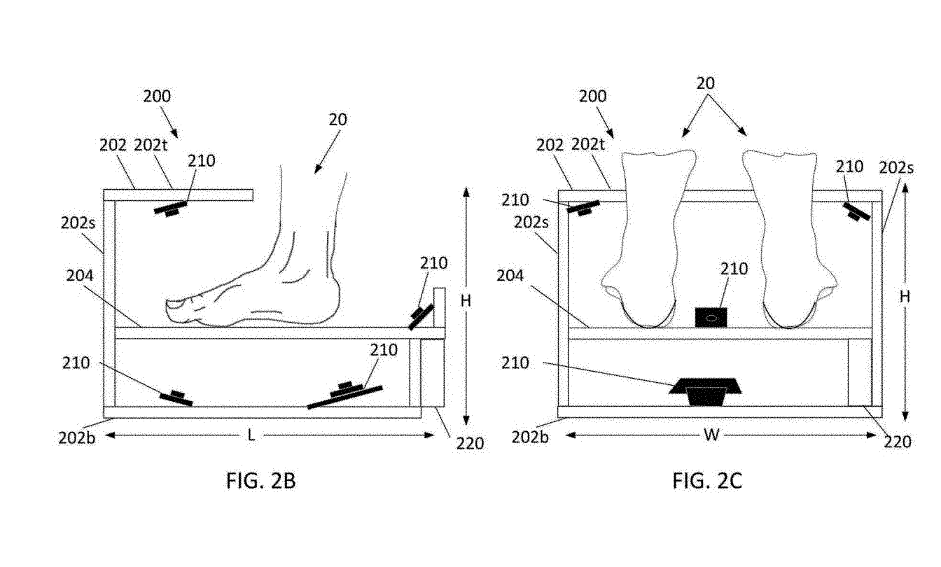

FIG. 2A is a schematic view of a process, according to one embodiment of the present invention, for scanning a foot. As shown in FIG. 2A, the scanning system 10 includes a display component 150 and a detachable scanning component 100. The scanning component is freely moved to different poses (e.g., eight different poses are shown in FIG. 2A) in order to capture different views of an object 20 (e.g., a foot). The foot may be in the air (e.g., with its owner crossing his or her legs) or may be resting on a surface (e.g., a supported transparent surface such as Lucite or glass, such that the sole of the foot 20 can be imaged). The term ‘freely’ implies that there are many trajectories to move the camera in front or around the subject. In one embodiment, the scanning system assists the user by providing the user with a path around the foot 20 that can efficiently produce good results.

Some embodiments of the present invention include communication features such as the network adapter 116 to transmit the images for local or cloud storage and processing. In some embodiments the images captured by the scanning system 10 are transmitted (for example, over the internet 16) to a remote processor 18 to generate a 3D model, and the 3D model may be transmitted back to the scanning device 10 and displayed 152 on the display component 150 of the scanning system 10. For instance, the scanning system 10 can produce a 3D cloud (an aggregated and aligned collection of 3D XYZ measurements from different views of the subject) and sparse color images from calculated camera positions, and can then send the data to the remote processor 18. The remote processor 18 can produce a polygon mesh of the subject (e.g., the foot 20) and perform texture mapping to apply actual color to the 3D scan. The results can be, for example, presented to the user directly from the remote processor 18, sent back to the scanning system 10 for display and manipulation, or provided to a third party (e.g., for further analysis and design of a customized shoe).

In other embodiments, the processing of the images to generate the 3D model is performed locally by the scanning system 10 itself (e.g., by the host processor 108 of the scanning system 10).

The results of the processing, whether by the scanning system 10 itself, by the remote processor 18, or by both, may include, for example, a 3D model of the foot, various measurements of parts of the 3D model of the foot, recommendations of particular types of shoes, and one or more designs of shoes and/or shoe components based on the scan. In some embodiments, the scanning system 10 includes a screen or display 114 to enable the operator to view the results, such as the 3D model of the foot and its measurements.

The measurements may include foot width, length (heel to each toe), instep circumference, joint circumference, foot curvature, and the like. These measurements are available from the 3D model of foot that is generated from the images captured during the scan. Furthermore, if all or part of the user's leg is included in the scan or depending on whether additional portions of anatomy are captured in the 3D model in addition to the foot or feet, the 3D model may provide information on clinical foot issues such as genu varum (or bow-leggedness) and foot surface injuries may be detectable. This detailed information about a foot shape can be used for designing corrective features in the custom shoes.

Various embodiments of the present invention may function in both in an online (or real-time) mode and an offline mode. In an online or real-time mode, the 3D model of foot is immediately available both in preview and final form during the scanning process. The preview form can assist the operator to ensure that all the data necessary to produce a complete 3D scan was successfully collected. For example, in an online mode, various measurements may be shown as “unknown” until enough of the foot has been scanned to determine those measurements. As a more specific example, the arch position measurement may be left as “unknown” until the underside (or sole) of the foot is scanned. In contrast, in the offline mode, the scanning system 10 may send collected data to offline resources such as a remote processor, and the system performs offline post-processing of the received data and to estimate or compute a high quality 3D model of the scanned object (e.g., a foot). Typical embodiments of offline scanning systems are processing servers, cluster-computers, and cloud-based computing infrastructures, but offline scanning systems may also refer to local processing resources (e.g., the host processor 108) operating in a batch mode, without providing real-time feedback to the user.

The processing performed when operating in an online or real-time mode is meant to be consumed by the user for preview and providing feedback for making adjustments to the scanning process, such as moving the depth camera or scanning sensor of the scanning system 10 to appropriate positions or adjusting the location or configuration of the object (e.g., the position of the foot). As such, the preview may be refreshed several times per second in order to provide a smooth, fluid user experience. On the other hand, the processing performed in the offline mode does not participate in such temporal-restrictions and generally is performed in a time that may span from a few seconds to a few minutes.

Some embodiments are also directed to capturing 3D models of a user's feet in different epochs during the user's life, thereby allowing the monitoring of any potential symptoms that can be detected in the shape of the feet and that may be corrected using historical data. Furthermore, statistical analysis of large samples of scans of feet can be used for designing better varieties of shoes for different activities for particular populations, by clustering the feet of similar users and identifying similar characteristics of the feet of those populations.

In embodiments of the present invention using hand-held 3D scanners such as that depicted in FIG. 2A may include a depth camera (a camera that computes the distance of the surface elements imaged by each pixel) together with software that can register multiple depth images of the same surface to create a 3D representation of a complete object (e.g., a foot 20). Users of hand-held 3D scanners need to move it to different positions around the object and orient it so that all points in the object's surface are covered (e.g., all of the surfaces of the foot 20 are seen in at least one depth image taken by the scanner). In addition, it is important that each surface patch receive a high enough density of depth measurements (where each pixel of the depth camera provides one such depth measurement). The density of depth measurements depends on the distance from which the surface patch has been viewed by a camera, as well as on the angle or slant of the surface with respect to the viewing direction or optical axis of the depth camera. The system may determine the location and orientation (collectively called the “pose”) of the camera with respect to the object at each image. This could be obtained from registration of the 3D point clouds measured from different viewpoints using various well-known methods such as the Iterative Closest Point (ICP) algorithm. These methods for camera pose estimation may also make use of the inertial measurement unit (IMU) 118.

In order to assist the user in obtaining sufficiently complete coverage of the object (e.g., complete coverage of the shape of the foot or of the relevant surfaces of the worn-out shoes), the 3D scanner may provide the user with guidance (e.g., user feedback). Systems and methods for providing this guidance are described, for example, in U.S. patent application Ser. No. 15/445,735, “System and Method for Assisted 3D Scanning,” filed in the United States Patent and Trademark Office on Feb. 28, 2017, the entire disclosure of which is incorporated herein by reference.

### Foot Scanning Apparatus

One goal of scanning an object such as a foot or a shoe is to produce an accurate 3D model of the object that captures the 3D geometry (including size) and visual surface color and texture. Designing a scanning apparatus is a challenging task particularly if the scanning device is to remain accurate and rugged against daily use by consumers and transportation (e.g., moved around to different parts of a store).

While aspects of embodiments of the present invention may be implemented by scanning an object such as a foot or a shoe using a handheld 3D scanner, performing such a scan may still be less convenient and less comfortable for the scanned person than a dedicated scanning apparatus. In addition, the use of such a handheld scanner may still require the operator of the scanner to undergo some specialized training.

Therefore, aspects of embodiments of the present invention relate to a system and method for the acquisition of surface and texture of an object, or of a part thereof, using several range and color cameras rigidly attached to a frame. In some embodiments of the present invention, a 3D scanner is a foot scanning apparatus is designed to be accurate to about 1-2 mm in order to capture measurements more precisely than the difference between different shoe sizes (around 3 mm). As a result, aspects of embodiments of the present invention may provide a low-cost and user friendly experience that can be operated by users with diverse technical backgrounds or no technical background.

FIGS. 2B and 2C are a cut away side view and a cut away back view of a foot scanning apparatus 200 according to one embodiment of the present invention. As shown in FIGS. 2B and 2C, the apparatus includes an enclosure 202 having a base 202b, a top 202t, and sidewalls 202s.

As shown in FIGS. 2B and 2C, some embodiments of the foot scanning apparatus include a platform 204 that user can step on with both feet 20. For example, a 40 cm (L) by 40 cm (W) platform may provide a good size platform for various sizes of feet. The height (H) of the enclosure 202 may depend on the particular model and camera technology used, as described in more detail below. For example, when the camera technology is a stereoscopic depth camera, a height (H) of about 60 cm may provide enough separation between the cameras 210 inside the enclosure 202. The platform may be made of a transparent material (e.g., glass or acrylic) that can handle the weight of a user, e.g. of 175 kg (380 lb.) or more. The transparent platform allows cameras to be placed underneath the feet 20 to provide views of the soles of the feet.

As shown in FIGS. 2B and 2C, multiple depth (or depth and color) cameras 210 are placed inside the housing 202 (e.g., mounted to the base 202b, top 202t, and sidewalls 202s) to provide camera views from top, back and under the foot platform. In some embodiments, the cameras 210 do not have moving parts. The number of cameras 210 depends on the field of view of the cameras used. One design factor in the placement of the cameras is to ensure that the each part of the foot (or feet) is visible by at least one camera (in other words, ensuring sufficient “coverage” of the object), as discussed in more detail below. The cameras 210 may be configured to communicate with a central processing unit 220 of the scanning system, for example, through wired or wireless communications channels such as universal serial bus (USB) or Bluetooth®. The central processing unit 220 may include a processor (e.g., an ARM or x86 architecture processor), dynamic memory, persistent memory, input/output controllers for interfacing with the cameras, and a network adapter (e.g., Ethernet or wireless local area network) for communicating with a network.

Overlap in the fields of view of adjacent cameras 210 can also be helpful for building the 3D model. For example, assuming n cameras capture a scene at substantially the same time, and assuming a normal distribution of the depth error measurement by each camera, the standard deviation (thus the depth error) of the aggregated measurement is reduced by SQRT(n), which is significant for building 3D models of objects. The overlap may also be useful for obtaining corresponding features in the separate depth maps generated by adjacent cameras. These corresponding features may be used to align and combine the depth maps when generating the 3D model.

Each of the cameras 210 may be a separate depth camera system. For example, each camera 210 may be a separate stereoscopic depth camera system that includes a plurality of two-dimensional (2D) cameras. Each of these two-dimensional cameras may include an image sensor (e.g., a CMOS image sensor) and an optical system configured to focus light onto the image sensor. The optical axes of the 2D cameras may be substantially parallel such that they image substantially the same portion of the object. However, the 2D cameras are also spaced apart by a fixed distance, thereby giving each 2D camera a slightly different view of the same portion of the object. As discussed above, these different views are used to generate a disparity map by matching features found in the images captured by the 2D cameras. In various embodiments, the image sensor may be configured to detect light in the infrared (IR) range, color (visible light or RGB) range, and combinations thereof (RGB-IR) ranges.

In some embodiments, each camera 210 is a separate 2D camera, where the cameras are spaced apart with overlapping fields of view. A depth map can be generated by performing feature matching between pairs of cameras. In some circumstances, this may be more difficult than in the case of calibrated pairs of cameras in stereoscopic depth camera systems, due in part to increased difficulties in matching views and accounting for scaling factors (e.g., due to differences in distance between the cameras and the matched feature), and in the absence of defined reference metadata.

Cameras with different characteristics can be used depending on the geometric details or texture materials of the object. For instance, a shoe may have leather on the sides, rubber at the bottom, and it may have some mixed material including metallic surfaces (e.g., for the eyelets) in top. The camera characteristics or tuning may be optimized for each one the sides for obtaining best raw color and depth images.

The individual bandwidth of the cameras can be aggregated to result in a much higher collective bandwidth (as compared to a single camera) for transferring sensor data to off-line processing nodes such as servers and cloud.

The scanning apparatus 200 may also include one or more illumination sources, such as visible light and invisible light projectors that are configured to project a pattern or patterns onto the object. Depth cameras may take advantage of a pattern that is projected in the same field view of the camera sensors. For example, for a stereoscopic depth camera, these patterns provide additional features that can be detected in the images, thereby improving the quality of feature matching between images, and thereby increasing the quality of the resulting 3D model. In some embodiments, each camera 210 includes a projection source configured to emit a pattern (e.g., emit patterned light) in a direction parallel to the optical axis of its depth camera. In the presence of other depth cameras, the depth error and spatial depth resolution of a first depth camera can be enhanced if it can image (e.g., detect) both the pattern projected from its own projection source and a second pattern projected from the projection source of a second depth camera.

In some embodiments of the present invention, the cameras 210 are fixed around the platform 204 where the user can conveniently place a foot or both feet (or a shoe or both shoes). The cameras 210 are configured to capture images of substantially all sides (including top and bottom) substantially simultaneously. As such, the user holds his or her feet still only for the duration of image capture (less than a second) and there is no need for the user to hold his or her feet still for a long period of time, as is generally the case with line scanning devices). In addition, if the object is in motion (e.g., if the user lifts his or her foot), the same camera can continuously scan the object from one view point as the object slides in front of the camera, while the other cameras scan the same object from other viewpoints. By the time the object has completely moved out of the sight of the cameras, the object is practically fully scanned.

In some embodiments, the precise location of cameras (camera pose) with respect to the foot or each other are not necessarily known, especially because the user may place his or her feet or shoes in various portions of the enclosure. The camera poses with respect to each other may be estimated with a multi-camera calibration or registration process, as described in more detail below. Alternatively, the pose of the camera can be determined by aligning features with the object or with a partially reconstructed 3D model of the feet. Estimating the relative poses of the cameras a priori can improve the pose estimation of the cameras assisting the 3D reconstruction algorithms.

Camera Placement

The placement of the depth cameras 210 on a rigid frame, such as the rigid enclosure 202, can be adjusted so as to obtain the desired coverage of the surface of the object 20 (e.g., the foot or feet or shoe or shoes) at the desired geometric resolution (e.g., distance between adjacent points in the point cloud). The depth cameras 210 may all have substantially the same characteristics (in terms of optical characteristics and pixel resolution), or may have different characteristics. In some embodiments, the cameras may be placed so that they image different portions of the foot's surface. In some embodiments, the fields-of-view (FOV) of two or more cameras are configured to overlap, resulting in some of the same surfaces of the object being imaged by multiple cameras. This can increase the signal to noise ratio (SNR) and can increase the effective geometric resolution of the scanning system 200.

Because the general shape of the object 20 (e.g., a foot or feet or a shoe or shoes) to be scanned is known in advance, at least approximately, the cameras 210 can be arranged, a priori, to cover all of the surfaces of the object 20 (or the portion of the object desired for the application) with the desired geometric resolution in the typical case (e.g., average foot and shoe size). In other situations, such as when scanning a child's feet or very large feet, the location of the cameras 210 may be manually adjusted in order to obtain the desired coverage and resolution.

As noted above, the cameras 210 may further include one or more color (visible light) cameras. In circumstances where the color cameras are separate from the depth cameras 210 (e.g., when the depth cameras 210 include only invisible light or IR cameras), the images captured by the color cameras may be applied as textures to the surfaces of the 3D model generated from the depth cameras 210.

Like the placement of the range cameras, the placement of the color cameras may also be chosen in accordance with various considerations. In some embodiments of the present invention, the color cameras are arranged next to the range cameras, so that both cameras in a “unit” image the same portion of space. In some embodiments, a high resolution, large field of view color camera is arranged to image a portion of the object that is imaged by multiple lower resolution depth cameras 210. However, for the sake of convenience, in the following discussion, it is assumed that the color cameras are co-located with the depth cameras 210 (e.g., as a separate color imaging module within the depth camera 210, having an optical axis substantially parallel to the optical axes of the 2D cameras of the stereoscopic depth camera, or integrated into 2D cameras that use an RGB-IR sensor).

Camera Array Registration

Suppose that multiple depth images are taken of an object from different viewpoints or poses in order to cover the desired portion of the object's surface at the desired resolution. Each depth image may be represented by a cloud of 3-D points, defined in terms of the distance of each pixel in the depth image from the depth camera. “Registration” is the process of combining multiple different point clouds (e.g., multiple different depth images) into a common reference frame, thus obtaining complete representation of the object's surface. The fixed reference frame can be placed at an arbitrary location and orientation; it is often convenient to set the fixed reference frame to be the reference frame of one of the depth cameras 210 in the scanning system 200.

Another situation that requires registration is that of a moving object, of which several range images are taken at different times from one or more fixed cameras. This may occur, for example, if the object is moved into or through the scanning apparatus 200, with the depth cameras 210 placed at fixed locations. In addition, moving an object in front of the cameras 210 may reduce the number of range cameras required for surface acquisition along the direction of motion. This is because multiple depth images can be taken of the object while translating (or rotating), obtaining a similar result to what would be achieved by a larger number of cameras taking images of the object in a fixed location or orientation. In addition, the ability to capture overlapping range images of the same surface area (if the frame rate is sufficiently high with respect to the object's motion) can be used to reduce noise in the surface estimation.

Registration of two or more point clouds (from different cameras looking at the same object, or of the same moving object imaged by the same camera) involves estimation of the relative pose (rotation and translation) of cameras imaging the same object, or of the relative pose of the moving object between acquisition times. If the cameras are rigidly mounted to a frame with respect to one another (e.g., rigidly mounted to the enclosure 202), with well-defined mechanical tolerances, the camera array system may be calibrated before deployment using standard optical methods (e.g., calibration targets). “Calibration” in this context means estimation of the pairwise relative camera pose (also referred to as “extrinsic data”) (see, e.g., Hartley, Richard, and Andrew Zisserman. Multiple view geometry in computer vision. Cambridge university press, 2003.). If, however, the system is designed to allow for manual camera placement or adjustment, calibration is performed after the placement or pose of the cameras is changed. Even in the case of a pre-calibrated rigid camera array, periodic re-calibration may be performed in response to undesired changes (e.g. structural deformation of the mounting frame).

Calibration may be performed in several different ways. A specific target could be used: one or multiple pictures of the target are taken by each pair of cameras, from which the pairwise relative pose is computed using standard calibration procedures [00101]. It is also possible to perform pair-wise calibration from pictures taken of a generic non-planar environment, using standard structure-from-motion algorithms. These image-based techniques exploit the so-called epipolar constraint [00101] on the pictures of the same scene from two different viewpoints to recover the rotation matrix and the translation vector (up to a scale factor).

The availability of range data enables a different modality for geometric registration. The point clouds generated by two depth cameras in the camera array viewing the same surface portion can be rigidly matched using techniques such as Iterative Closest Point (ICP) (see Hartley)[00101], which produces an estimation of the relative camera pose. Image-based and range-based registration techniques could be combined for improved reliability. Range-based techniques may also be used when the images contain few “feature points” that can reliably matched across views (as image point matching is a necessary component of this process). Image-based techniques [00101] may be used in the case of planar or rotationally symmetric surfaces, when point cloud matching may be ambiguous (i.e., multiple relative poses exist which may generate geometrically consistent point cloud overlap).

Iterative Closest Point is an iterative method that is more effective when an initial approximate pose is provided as input. In the case of an array of depth cameras 210 array attached to a rigid frame such as an enclosure 202, the approximate relative pose of the cameras can be computed by simple methods such as detecting the locations of markings on the enclosure and goniometers at the camera attachments. This information can be used to initialize the ICP process, which may thus be made to converge in just a few iterations. Image-based or range-based registration may need to be conducted only periodically, when there is a reason to believe that the cameras lost calibration or when a camera has been re-positioned; or continuously, at each new data acquisition. As such, in some embodiments of the present invention, the interior of the enclosure includes marks and/or goniometers to assist in the self-recalibration of the scanning apparatus.

In the case of an object moving during scanning, in which several depth images are captured by one or more depth cameras, point cloud registration involves estimation of the relative pose of the object during the various image acquisition times. This registration can be achieved again through the use of ICP. Assuming the object moves rigidly, the point clouds from two range cameras are, for their overlapping components, also related by a rigid transformation. Application of ICP will thus result in the correct alignment and thus in an “equivalent” pose registration of the two cameras, enabling surface reconstruction of the moving object. It is important to note that even if each camera in a perfectly calibrated array takes only one image of a moving object, the resulting point clouds still need to be registered (e.g., using ICP) if range image acquisition is not simultaneous across all cameras.

In embodiments where the color cameras are separate from the depth cameras (e.g., not RGB-IR sensors), the color cameras may need to be registered with the depth cameras, and these may be broadly grouped into two cases. In the first case, the color cameras are rigidly attached to the range cameras, forming a unit that can be accurately calibrated prior to deployment. As such, registration of the depth cameras with one another will also result in the registration of the color camera of the same unit. It may be safely assumed that, with proper mechanical attachment and packaging, the color and range cameras may not need further calibration during their operational lifetimes.

In the second case, the color cameras may be calibrated with the range cameras using image-based methods.

In the case of moving objects, time synchronization between the capture of images by the color camera and the depth camera significantly simplifies the registration of color images with depth images. In the case of a fully integrated range color camera unit, time synchronization can be achieved through electrical signaling. If the color and the range cameras cannot be electronically synchronized, it may still be possible to obtain geometric registration between color images and depth image if the images can be correctly time-stamped, and if the object motion can be estimated. In this case, point clouds can be rigidly transformed to account for the time lag between the range and color image acquisition.

As discussed above, in some circumstances, such as when imaging feet that are particularly large or particularly small, the cameras 210 may be repositioned in order to improve the coverage of the object. In some circumstances, the change in the position of cameras 210 may invalidate the pre-defined registration information (e.g., the poses of the cameras) that provides a convenient method of estimating pose of the cameras. As such, some aspects of embodiments of the present invention are directed to automatically updating the registration in accordance with the repositioning. In one embodiment, if the intrinsic matrix of cameras is known, then the camera poses can be re-estimated during the scan in a manner similar to the method of registering images using model-based pose estimation when moving a hand-held scanning sensor around the object.

In summary, a depth image effectively represents a “cloud” of 3-D points, which can be used to describe the portion of a surface visible by the depth camera. If a plurality of depth cameras are placed at different locations (or at different poses), and the cameras are properly oriented to image different portions of the object 20, it is possible to acquire a larger surface area that would otherwise be visible by a single camera. Merging views from multiple cameras involves the information about the pose (location and orientation) of each camera, so that all point clouds generated by the various cameras can be aligned to a common reference frame. This pose information can be obtained through geometric calibration of the cameras. In addition (or alternatively), multiple point clouds can be aligned using algorithms such as Iterative Closest Point (ICP), which automatically computes the relative camera poses by optimizing a properly chosen alignment metric. A point cloud, possibly obtained from merging multiple aligned individual point clouds as explained above, may be processed to remove “outlier” points due to erroneous measurements (noise), or to remove structures that are of no interest (e.g., background objects). For example, the range images likely contain data points corresponding to the portion of the belt on which the object sits; these points can normally be detected by fitting a “ground plane” structure at the bottom of the point cloud.

In some embodiments, the cameras 210 may each have an onboard processor that may be configured to generate a point cloud based on the captured image from a part of the foot that the depth camera images. In that case, the cameras 210 may transmit the generated point clouds to a central processing unit 220 to be combined. If the cameras 210 do not include onboard processors, the raw frames may be directly transmitted to the central processing unit 220, and the central processing unit 220 creates a point cloud for each camera. In some embodiments, as discussed above, the process of generating the 3D point clouds may also be performed by a remote processor 18, which may communicate with the central processing unit 220 through a network communications interface (e.g., an Ethernet connection or a wireless local area network connection).

The central processing unit 220 may be configured to perform registration by combining multiple different point clouds into a common reference frame, thus obtaining a representation of the surface of the object as a 3D model, such as the model depicted in FIG. 3. The resulting 3D model can be represented as 3D point cloud or 3D mesh.

FIG. 3 depicts eight different views of a single 3D model of a foot as scanned by a 3D scanning system 10 according to one embodiment of the present invention. The 3D model of a foot can be represented at least in two different forms: a 3D-cloud format and a 3D mesh format.

In aspects of embodiments of the present invention that use a 3D-cloud format, the surface shape of foot is represented as points having x, y, and z (alternatively written as <x,y,z>) values in a 3D coordinate system. (A 3D cloud format may alternatively use other 3D coordinate systems, such as a polar coordinate system rather than a Cartesian coordinate system.) The unit of individual coordinates can be a typical geometric distance measurement such as millimeters (mm) or inches, etc.

Generally, a cloud of approximately 25,000 3D points would provide a sufficiently detailed model of a foot for at least some aspects of embodiments of the present invention. In more detail, the surface density of the 3D cloud is determined by the surface resolution requirements of the underlying application. For instance, a section of surface having two millimeter (2 mm) surface resolution (e.g., cloud points spaced about 2 mm apart) would have about 25 points per square centimeter area of the surface.

The center of a coordinate system for the foot can be chosen as a convenient, but arbitrary, point. For instance, the center can be the center mass of a foot 3D cloud. The measurement methods of embodiments of the present invention generally relate to the relative position of the points on the foot model (e.g. the distance from the point representing the extremity of the heel to the point at the tip of a toe).

In aspects of embodiments of the present invention that use a 3D mesh format, the 3D model is represented as a collection of vertices, edges, and faces. In a typical triangle mesh format, the faces appear as connected collection of triangles. A mesh representation allows for fast rendering of different views of the model (e.g. from top, from bottom, from side, or any other view in-between) using graphics capabilities of modern computers (e.g., a graphical processing unit).

For some measurements in embodiments of the present invention, the 3D cloud format provides enough detail to generate accurate measurements. Using a 3D cloud format can avoid the computation overhead of building a 3D mesh from the scan.

The 3D model may be stored in a 3D graphics file format (or geometry definition file format) such as Wavefront .obj. In some circumstances, the file format may not include units for scaling the stored model to real world dimensions. In such circumstances, metadata can be stored in association with the file to relate the measurements in the stored data to real world data (e.g., 1 millimeter to 1 unit in the 3D model).

Depending on the resolution of a 3D scanner, using a low cost mobile scanner, such as one of the devices from Aquifi Inc. of Palo Alto, Calif., can capture and produce real world measurements of a foot shape down to linear sub-millimeter dimensions, which may be sufficient resolution for designing customized shoes. Such 3D scanners may be significantly less expensive than the line scanning devices and pin gauge systems for taking measurements of feet.

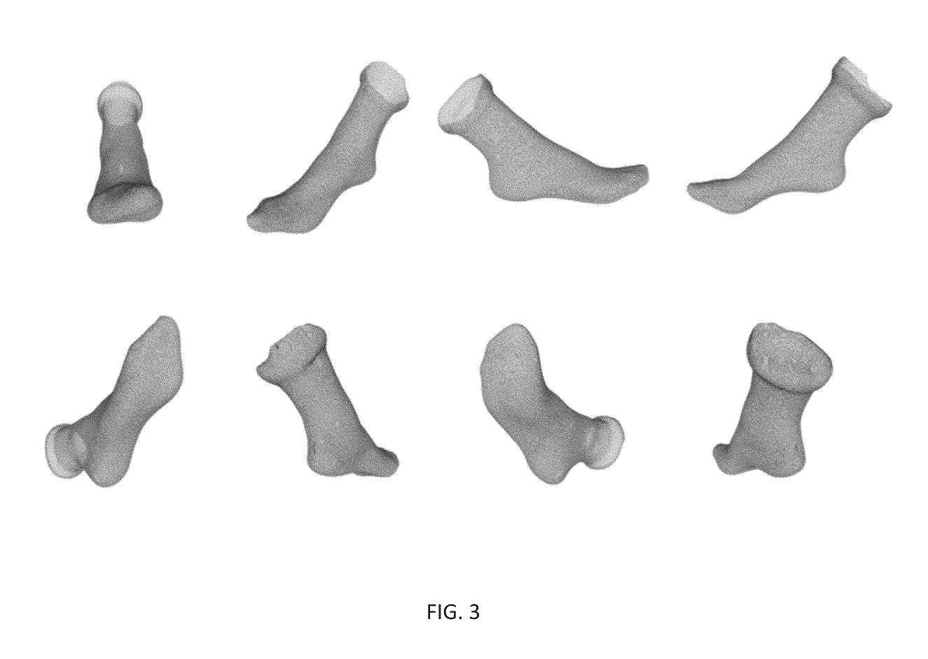

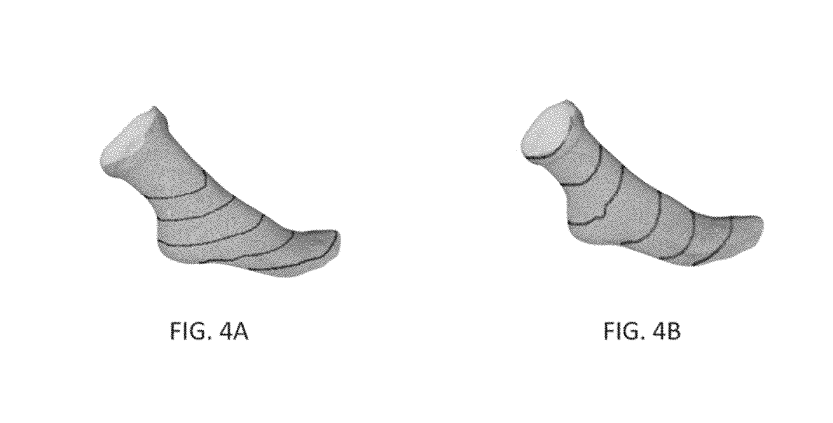

FIGS. 4A and 4B depict views from FIG. 3 with the addition of contour lines. A sufficiently complete 3D scan of a foot can provide sufficient measurements to identify a proper shoe size. For example, a shoe size is typically identified based on a toe to heel length measurement, and such a measurement can be made on a 3D model of a foot to the precision of standard shoe sizes (approximately ⅓ cm). Furthermore, the 3D model can also provide other information, such as the width and volume of the foot. For example, foot scanning may capture conditions such as severe foot edema (excessive swelling) that may be endemic or transient, and may be used to further customize shoes to account for such conditions (e.g., reducing pressure points in the case of foot edema).

Furthermore, a 3D model of a foot captured at rest while the person is standing can be analyzed to identify irregularities in foot posture, such as a degree of pronation (e.g., over-pronation, neutral pronation, and under-pronation or supination). One diagnostic clinical tool for quantifying degrees of pronation (e.g., over-pronation, neutral pronation, and under-pronation or supination) is described in Redmond, Anthony “The Foot Posture Index: Easy quantification of standing foot posture” (August 2005), available at https://www.leeds.ac.uk/medicine/FASTER/z/pdf/FPI-manual-formatted-August-2005v2.pdf.

### Scanning Worn-Out Shoes

Some aspects of embodiments of the present invention are directed to performing a 3D scan of worn-out shoe. While a 3D scan of a foot may provide measurements of the size and shape of the foot at rest, a 3D scan of a worn-out shoe can provide information about wear patterns (e.g., which portions of the outsole of the shoe are most worn down) and therefore information about the dynamic behavior of the owner of the shoe in, for example, walking, jogging, or participating in sports.

This information can be applied to a footwear design and fabrication process to match the design of a shoe to actual foot dynamic of a customer such as point of landing, roll of the foot after landing (foot stride), and during walking or running. See for instance, “Vernon, Wesley, Anne Parry, and Michael Potter. “A theory of shoe wear pattern influence incorporating a new paradigm for the podiatric medical profession.” Journal of the American Podiatric Medical Association 94.3 (2004): 261-268.)” For instance, excessive wear outside (or lateral) portions of the outsoles of the shoes may be sign of supination or under-pronation.

In embodiments of the present invention, a shoe or a pair of shoes may be scanned to generate a 3D model in a manner similar to the manner of scanning a foot or feet, as described above. For example, a handheld scanning system or a scanning apparatus with multiple depth cameras may be used to scan the shoe or shoes.

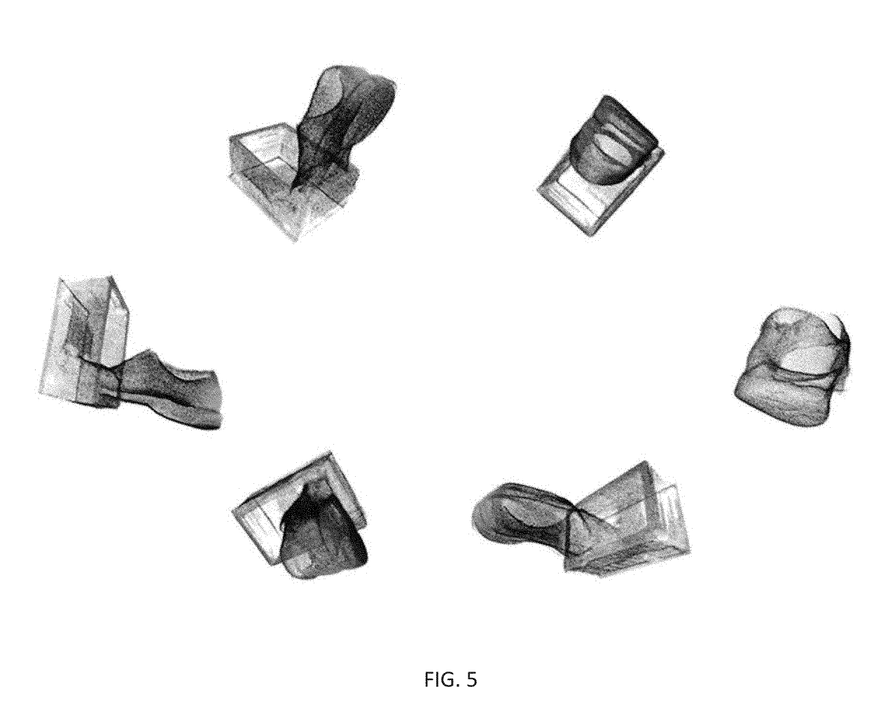

FIG. 5 depicts six views of a single 3D model of a worn shoe, where the model is captured according to embodiments of the present invention. Because the captured 3D model includes information about the entire shape of the shoe, measurements can be made of various portions of the shoe. For example, the thickness of the tread on the outsole can provide information about whether the owner of the shoe exhibits supination or pronation of the foot during walking or running. In addition, when the scanning system captures color information, discoloration of the outsole can provide additional information about the wear patterns.

In some embodiments of the present invention, the scanning system may use penetrative wavelengths such as ultrasound or X-rays to further model the interior of the shoes. This may provide additional information such as which portions of the insole are compressed.

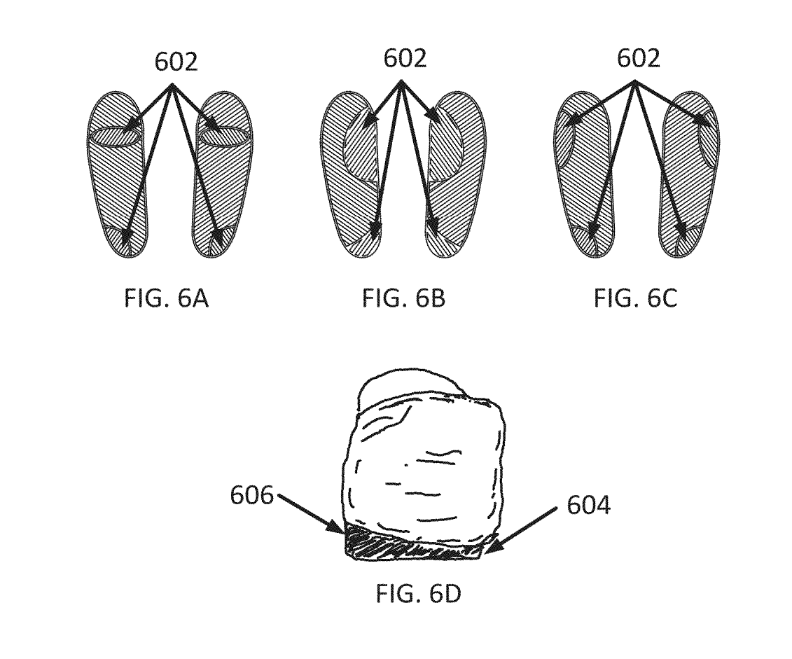

FIGS. 6A, 6B, and 6C are examples of different wear patterns of a shoe, where FIG. 6A indicates normal wear (or neutral), FIG. 6B indicates over-pronation, and FIG. 6C indicates supination (or under-pronation). Aspects of embodiments of the present invention allow the automatic detection and marking of portions 602 of the outsole as being worn-out, based on the thickness of the outsole tread in the 3D model (e.g., smooth portions of the outsole are considered worn out, whereas “rough” portions indicate the presence of tread). FIG. 6D is an illustration of a back portion of a right shoe in which the lateral (right) portion 604 of the heel of the outsole is worn significantly more than the medial (left) portion 606. The severity of the condition of the user (e.g., pronation or supination) can be inferred from the relative amount of wear in different parts of the shoe.

### Taking Measurements and Recommending Shoes Based on Scans

Some aspects of embodiments of the present invention are directed to using the 3D scan of the foot (or feet), or the scan of the worn-out footwear (or pair of footwear) to automatically identify sizes and models of shoes that would fit. While the sizing of shoes made within a single model or made by a single manufacturer may generally be consistent, sizing between different manufacturers may vary. For example, a person may find that a size 9 shoe from a first manufacturing brand fits well, but may find that a size 9 shoe from a second manufacturing brand does not fit as well as a size 8.5 shoe from that second manufacturing brand. Furthermore, shoes sometimes also come in a variety of widths, sometimes designated from narrow to extra-extra-wide, sometimes designated with letters from A to E with numbers, such as 2A for extra narrow and E for wide. Determining a proper fit may sometimes require trying a variety of combinations of sizes to identify a shoe with a good fit, such as a size 8.5B (narrow width) versus a size 9D (standard width). These differences may be due to different methods used by the manufacturers to measure the dimensions of a shoe, and may also be due to variations in the internal volume of the shoe, such as the volume of the toe box, which may vary based on the size of the vamp.

As such, one aspect of embodiments of the present invention is directed to using a 3D scan of a user's foot or feet to automatically identify the sizes of various shoes that would fit the user's foot. A 3D scan of the user's worn-out shoes may also be used to identify shoes of a similar style and that correct for particular conditions of the user, such as pronation or supination.

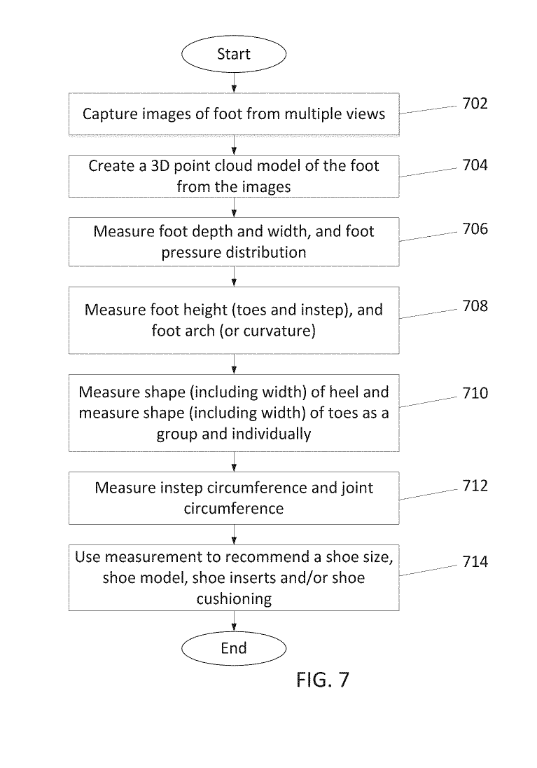

FIG. 7 is a flowchart illustrating a method for collecting and analyzing a 3D scan of a foot according to one embodiment of the present invention. In some embodiments of the present invention, these operations are performed by a processor that is local to the scanning, such as the host processor 108 of the scanning system 10. In other embodiments, some of the operations are performed by a local processor and other operations are performed by a remote processor 18, such as a cloud based computing system. For the sake of convenience, the operations will be referred to as being performed by a “processor,” with the understanding that these operations may be performed either locally or remotely in different parts of the method.

In operation 702, the processor controls the scanning system 10 to capture depth images or depth maps of a foot or a pair of feet 20 from multiple views. For the sake of convenience, the method will be described in the context of scanning one foot, but embodiments of the present invention are not limited thereto, and may encompass scanning two feet at once. In some embodiments, color images are also captured of the foot 20.

In operation 702, depth images (and, in some embodiments, color images) are collected of the foot 20. In some embodiments, the depth images are captured using a handheld scanning system, such as the scanning sensor 100 and display 150 described above and shown in FIG. 2A. In other embodiments, the depth images are captured using a scanning apparatus with substantially fixed cameras such as the foot scanning apparatus 200 described above and shown in FIGS. 2B and 2C.

In embodiments of the present invention using a handheld scanner, an operator, such as a salesperson at a shoe store, may move the cameras of the handheld scanner (e.g., the scanning sensor 100) to capture images of the relevant surfaces of an object such as a user's foot or feet or a shoe or a pair of shoes. The display 150 may provide real-time feedback to the operator to show which portions of the object have been imaged, which portions need further imaging, and the current computed measurements of the feet. During the scanning process, the user may be asked to remain still, such that the scanning system can obtain an accurate scan of the feet.

In embodiments using a scanning apparatus 200 with substantially fixed cameras 210, the processor is configured to send a command to each camera such that each of the cameras captures respective images at substantially the same time (e.g., by broadcasting a single command that is received by all the cameras). The cameras 210 may be registered to each other prior to beginning the scan process. As described above, the registration provides the mathematical constraints to align images from different views of the foot into a single 3D coordinate system. During the capture of images, the foot or both feet can remain either stationary, or may move along a short path. In the former case, the foot 20 stays substantially still during the capture period (e.g., one frame, which may be less than one second). In the latter case, the user may be asked to move his or her foot up and down, perhaps by 2 to 3 inches. During this motion, each of the cameras 210 can capture multiple views of the foot. If both feet are scanned at the same time, the user can raise his or her feet one at a time.

The depth and, if applicable, color images captured by the scanning sensor 100 or the scanning apparatus 200 may be transmitted to a central processing unit using wired or wireless communication methods (e.g., universal serial bus USB, Ethernet, WiFi, Bluetooth, etc.). The processing unit can be a local processor such as the host processor 108, the central processing unit 220, or a remote processor 18.

In operation 704, the processor computes a 3D model of the foot from the separate images captured by the scanning system. The multiple depth maps may include depth maps captured at different times by the handheld scanning system 100 or the depth maps captured by the different depth cameras 210 of the foot scanning apparatus 200. One technique for creating a 3D model of an object from multiple, separate 3D clouds (e.g., separate depth maps) is Iterative Closest Point (ICP). This technique finds the corresponding points (e.g. tip of the big toe) in at least two depth images and tries to minimize the distance between the matched points. The technique iterates over such points and over multiple images obtained from the same object from different views. The outlier points that are visible to the cameras but not part of the foot are automatically removed. The resulting data structure is a refined 3D point cloud that defines the correct geometric shape of the object (e.g., a foot or a shoe) in 3D.

In operation 706, the processor measures foot depth and width, as well as foot pressure distribution by projecting the model to the bottom plane (e.g., the plane of the sole of the foot) or the plane that is parallel to the plane of the platform 204. The resulting projection is essentially the silhouette of the foot as if someone has traced the foot of the user on a paper. The width and length of the foot can be measured from this silhouette. Furthermore, the silhouette provides a surface estimate of the footprint of the front (toes or forefoot) and back (heel) of the user's foot.

The bottom view of 3D model of the foot also provides information about the size and depth (angle) of the foot arch, which is not available from the 2D silhouette.

In operation 708, the processor projects, for example using orthogonal projection, the 3D model of the foot to left and right side planes to create side silhouettes of the foot. The side planes may be defined as planes vertical to the bottom plane that envelope the user foot 3D model from the sides, and front and back. The side silhouettes provide information about the heights of the toes, and also about the shape of the top part of the foot (e.g., the instep). The medial side silhouette (e.g., the left side of the right foot or the right side of the left foot) provides information about the height of the arch, and can be used to detect various degrees of flat-footedness. A 3D view of the side of the foot also provides information about the arch of the foot, complementing the data obtained from the bottom view.

In operation 710, the processor projects, for example using orthogonal projection, the 3D model of the foot toward the front (toe side) and back (heel side) planes to create front and back silhouettes of the foot. The front silhouette provides a measurement of the cross-sectional shapes of the toes and can detect conditions such as missing toes, protrusions, or other potentially sensitive portions of the feet. The back silhouette provides measurement of the size and shape of the heel and can detect conditions such as foot pronation (inward tilt), or foot supination (outward tilt). These are medical conditions that may be corrected by custom shoe inserts.

In operation 712, the processor performs additional foot measurements in three dimensions. For example, a geodesic-type measurement of the 3D shape of the foot can provide accurate measurements of instep circumference, joint circumference, ankle circumference, and so on. Such measurements may be particularly useful for specialized sport footwear such as ski boots and may determine, for instance, whether a pronation condition is rooted in the ankle or the foot.

The measurements may be saved locally or in the cloud for future use by the same user. For instance, the foot measurements of a client can be captured on behalf of an e-commerce site, which would allow the user to order shoes that precisely fits the user's foot in the future, without going through another foot scanning process. Such measurements may also be adjusted based on the preference of users (such as a preference for a looser fit).

In operation 714, the measurements may be used to recommend a shoe size, a shoe model, shoe inserts, and/or shoe cushioning. For example, the length and width measurements may be used to identify particular shoe sizes that would be suited to these feet based on the actual measurements of the interiors of shoes (e.g., taking into account brands or models that “run large” versus brands or models that “run small”). In addition, the measurements of foot height, instep circumference, and foot shape may also be used to refine the group of shoes (e.g., to identify shoes having a larger internal volume to accommodate feet with high insteps).

In one embodiment of the present invention, the processor makes the recommendation by accessing information (stored, for example, in a database) about the shape of shoes that are available for purchase. For example, penetrative scanning systems such as X-rays or ultrasound may be used to collect data about the shapes the interiors of a large collection of shoes.

In some embodiments of the present invention, information about which shoe the customer ultimately selected may be supplied back to the recommendation system. Furthermore, some embodiments of the present invention allow a user to rate the shoes that they are wearing, based on comfort, support, and other factors. This information may be used to improve or refine information about which types of shoes best fit the various feet of customers. For example, machine learning (e.g., a neural network) can be trained based on mapping features of feet (e.g., measurements of various portions of the feet, and the presence of particular anatomical features such as pronation, supination, and the like) to suitability for various types of shoes.

Furthermore, in some embodiments of the present invention, a processor may cluster together different models of shoes based on similarity of the shape of the internal measurements of the shoes. As such a user can be automatically matched with a group of shoes that would fit his or her feet, based on the measurements from the 3D scan.

### Designing Custom Shoes Based on Scans of Feet and Worn Shoes

Some aspects of embodiments of the present invention are directed to designing custom shoes based on the scans of feet as described above and providing these customized shoe designs as shoe recommendations. Furthermore, some embodiments of the present invention are directed to using information from scans of worn shoes to design custom shoes. The 3D models of the user's feet and the information obtained from the 3D models of the worn shoes of the same user can provide information and measurements about certain common foot conditions during use, such as walking or jogging. This information can be used to incorporate certain custom features into the shoe design. The resulting design can be manufactured using processes such as injection molding and 3D printing. Such a custom shoe may also help other user side-effects such as ankle and knee discomfort. The method can also be used to design the inner lining (insole) of the shoe with shapes commensurate with the shape of the foot and wear pattern. For example, additional arch support may be provided to a user with flat feet, where the location of the arch support is identified based on the particular shape of the user's feet (e.g., a particular location or region between the big toe and the heel).

In some embodiments of the present invention, the design of the custom shoes is automatically performed by a computer processor coupled to memory. The processor may be the host processor 108 of the scanning system 10, or may be a remote processor 18, or may be combinations thereof, with some portions of the computation being performed by the scanning system 10 and some portions being performed by the remote processor 18.

In some embodiments of the present invention, a set of design rules is stored in memory. These design rules may take, as input, measurements from the 3D models of the feet and the worn shoes in order to output design parameters for a custom shoe, or portion of a custom shoe.

For example, for a user having feet and shoes that show a neutral posture, as shown in FIG. 6A, the rules may generate a balanced design to attempt to assist the user in maintaining good walking posture.

Over pronation, as depicted in FIG. 6B, can produce discomfort in different parts of the body. In order to increase comfort, a shoe design may be designed to provide cushioning that can disperse the shock of foot landing in the lower foot rather than transmitting the shock to the legs and upper body. Strengthening or supporting the arch of the foot can help with this condition. As such, the rules may specify a design for additional arch support for users that exhibit over pronation, where the amount of arch support (e.g., the firmness of the material) and height of the arch depends on the degree of the over pronation and the shape of the foot, as measured from the 3D models of shoes and feet.

For users exhibiting supination or under pronation, as depicted in FIG. 6C, the rules may specify that additional cushioning be provided in the midsole region. Design and automatically fabricate the cushioning and material strength of a custom shoe from the wear pattern of 3D model of the same user's worn shoes.

The design rules of embodiments of the present invention are not limited to the above rules and may also include other rules to accommodate other circumstances, such as users who have one or more missing toes, stress fractures, or other characteristics that are detectable in a 3D scan of the foot and/or detectable in the 3D scan of the shoe, and that can be accommodated for in the design of various portions of the shoe.

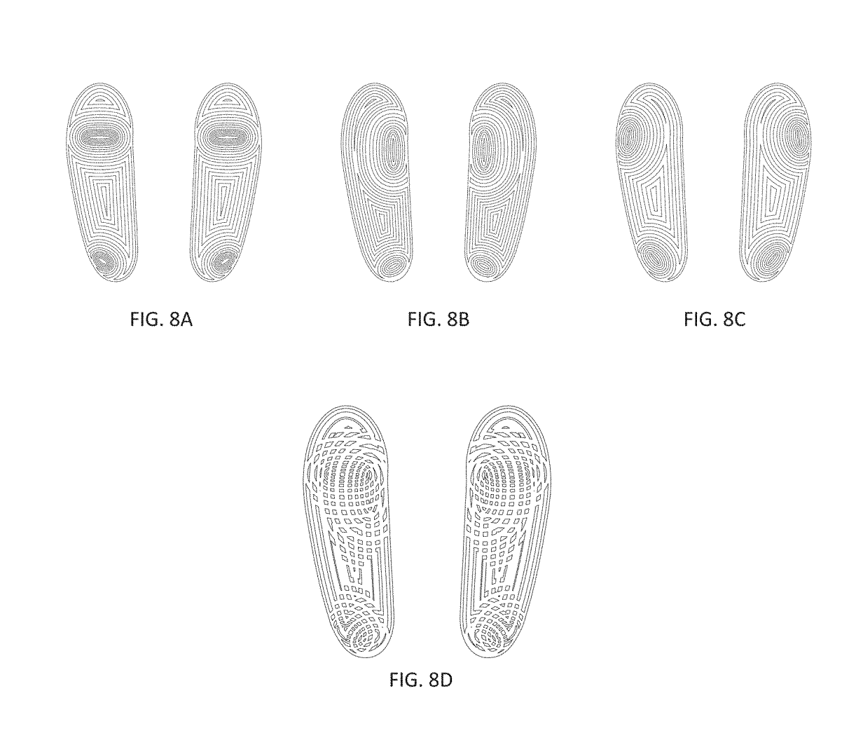

For example, FIGS. 8A, 8B, and 8C depict exemplary insole or under-sole constructions of a shoe respectively reflecting normal wear, over-pronation, and supination or under-pronation automatically designed according to one embodiment of the present invention. The contour lines reflect the special construction measures that can be applied to the design on the specific parts of the sole to influence the shape or even the weight of different sections of insole or outsole. These special construction measures include, but are not limited to, such fabrication factors as strengthening the section by a denser fabrication lattice, choice of the material (e.g., materials of different density or elasticity), variable density cushioning, thickness, or even embedding exotic features such as electronic circuitry or Micro-Electro-Mechanical Systems (MEMS) structures, which may be used to absorb vibrations. For example, the regions with denser contour lines correspond to the regions of higher wear, as shown in FIGS. 6A, 6B, and 6C. These areas may be strengthened in the design so that they do not wear out as quickly. The information obtained from the scan of the feet and the shoes may also be provided to a professional to provide advice to the user on walking and/or running technique.

This approach can also leverage larger volume production of semi-customized shoes or partial customization by combining the fabrication of generic shoe (e.g., a standard shoe upper and insole) with other portions that are customized based on a custom foot and worn shoe scan. FIG. 8D depicts an example of an outsole for custom shoes that is automatically customized based on 3D scans of feet and based on the wear patterns of worn-out shoes, as captured in the 3D scan of the worn-out shoe, according to embodiments of the present invention. FIG. 8D depicts a tread pattern automatically generated for a user with a supination condition, made by mixing a normal shoe design with the data collected from the user's feet and from the user's worn shoes. In addition to remedial factors such as tolerance to wear, the wear patterns may also be used to improve the traction lifetime of a shoe. Shoe soles that are expected to endure uneven wear may be designed to continue to provide traction even after one side of the shoe is significantly worn down. A section of the outsole may be given deeper than average “voids” to allow it to maintain its grip even after the top layer of the outsole has been worn away. Conversely, sections of the sole that expected to receive below average amounts of wear may have their tread pattern intentionally handicapped by reducing the amount of contact those surfaces have with the ground. This would serve to make the user experience more consistent over the life of the shoe and not expose the user to the possible dangers of shoes with uneven traction. This customized outsole can be attached to a standard shoe, instead of the generic outsole, in order to provide the benefit of partial customization.

Similarly, embodiments of the present invention may also be used to assist in capturing information for designing a customized foot orthotic, which may replace an insole in an otherwise standard (not customized) shoe.

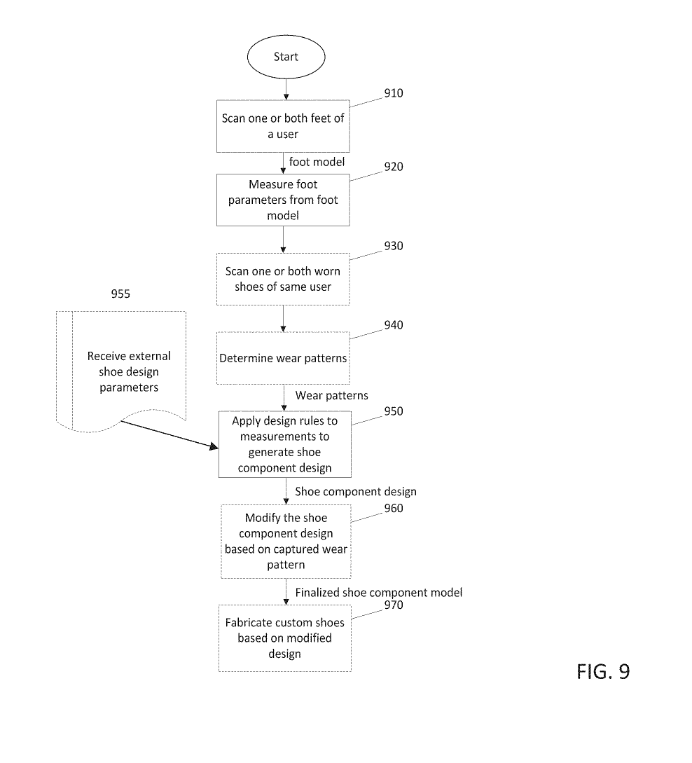

FIG. 9 is a flowchart illustrating a method for computing shoe recommendations in the form of designing custom shoes based on a 3D scan of a user's conditions according to one embodiment of the present invention. The method will be described herein in the context of the scanning device 10 performing scanning operations and processing of the scanned models being performed by the host processor 108 of the scanning device 10 or a remote processor 18, which will generally be referred to herein as the “processor,” even though embodiments of the present invention encompass circumstances where different operations are performed by different computing devices.

In operation 910, one or both feet are scanned using a three-dimensional scanning device according to embodiments of the present invention, such as a handheld depth scanner or a scanning apparatus (described in more detail below). In some embodiments, if only one foot is scanned, the 3D scan of the other foot can be estimated from the scanned foot (assuming left/right foot similarity). In some embodiments, the scanning process produces a 3D point cloud (PCL), as described above, and the PCL may be converted to a mesh to produce a 3D reconstruction or 3D model of the scanned foot or feet. Three-dimensional scanning systems according to embodiments of the present invention are capable of obtaining 3D scans of feet more quickly and at lower expense than comparative devices that may use line scanners or gauge pins.

In operation 920, the processor computes measurements based on the 3D model of the foot. Assuming the 3D model is accurate, the measurements will correspond to physical characteristics of the user's actual foot. As such, the model can provide information such as the heel to toe length of the foot and width of the foot (that would typically be measured using a Brannock Device®), in addition to other measurements such as height of the instep, arch height, arch location, location of the ball of the foot, and the like, that can be used to fine-tune a shoe size or to customize an insole to a user's foot.

In some embodiments of the present invention, one or both of the user's worn-out shoes is scanned in operation 930. The scanning process in operation 930 is substantially similar to the process for scanning feet, and, in some embodiments, is performed by the same equipment (e.g., a handheld scanner or a foot scanning apparatus described in more detail below).

In operation 940, the processor extracts the wear pattern of user worn shoe(s) (e.g., the thickness of the remaining tread across the outsole) from the scan of the shoe or shoes. As discussed above, these wear patterns can be used to infer the dynamic walking behavior of the owner of the shoes, such as whether the user exhibits pronation or supination. To quantify the amount of wear, in some embodiments, the processor may compare the scanned model with a stored 3D model of a new shoe to determine which parts are missing. The stored 3D model may be from a database of scanned, new shoes or may be a scan of the same shoe that was captured when the shoe was new. In some circumstances, the stored 3D model shoe may be a different shoe size from the shoe size of the scanned, worn-out shoe. In such circumstances, an appropriate 3D transformation is applied to one of the models (the scanned model or the stored model) such that the two models are comparable.

In some embodiments, such as in cases where a model of a new shoe is not available, the processor is configured to perform a virtual reconstruction of the shoe by virtually adding the worn sections back to the scanned model. The scanned worn shoe can then be compared to the virtually reconstructed shoe. For instance, the original heel thickness of a shoe can be determined or estimated from a part of the heel that is not worn out. As such, the difference between the original thickness of the heel and the thickness of the worn parts of the heel can be used to compute or to estimate the amount and shape of the wear across various portions of the outsole.

In operation 950, the measurements from the foot model in operation 920 are used to produce a design for one or more shoe component such as an insole, an outsole, and a shape of a vamp. The processor may also receive external shoe design parameters in operation 955. These external design parameters may include considerations such as shoe style (e.g., flats versus pumps versus heels), shoe price range (for types or complexity of customization), shoe type (e.g., dress shoe versus athletic shoe versus ski boot), material (e.g., canvas versus leather upper or leather versus rubber outsole), color, and other commercial and technical information about the target shoes.

As discussed above, various aspects of the design may be controlled in accordance with a set of rules or a rules engine, where the rules take the various measurements from the foot model (or the foot model itself) as input, along with the external design parameters, if applicable, and automatically generates designs of shoe components in accordance with the input. For example, a rule for designing a vamp may output a vamp that is larger (e.g., more material) when measurements of the height or circumference of the instep of the scanned foot are large.

In operation 960, if information about wear patterns from operation 940 is available, the processor may use this information to further modify and customize the shoes design in accordance with the walking pattern of the user, as described earlier. For instance, the special construction measures including such fabrication factors as strengthening a section of the outsole by a denser fabrication lattice, choice of the material, variable density cushioning in the insole, thickness, or even embedding exotic features such as electronic circuitry or Micro-Electro-Mechanical Systems (MEMS) structures into the components of the shoe. Other personalization factor can also be applied at this stage, such as applying particular patterns or designs (e.g., pictures) into the design of the tread of the outsole.

In operation 970, a finalized model of a shoe component, such as an outsole, is output as the shoe recommendation from the design process of operations 950 and 960. The finalized shoe component can then be fabricated by supplying the finalized component or components to appropriate machines. The fabrication may include producing substantial part of a pair of shoes or producing different parts of the shoes for subsequent assembly. In other embodiments, the finalized design is fabricated automatically by machines such as 3D printers (e.g., for insoles and outsoles), and computer numerical controlled machine tools, such as laser cutters. In some circumstances, some components may still be fabricated manually, in which case the design is supplied to a shoemaker.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

For example, the terms processor and memory, as used herein, may be used to refer to a single processor and its associated memory and may also be used to mean multiple different processors, each associated with a separate memory, where these processors may be in the same computing device (e.g., a multi-core processor, or a multi-CPU mainboard), or may be spread or distributed across multiple computing devices (e.g., in the case of a computing cluster, or a client computing device in communication with a server).

What is claimed is:

1. A method for generating shoe recommendations comprising:
capturing, by a scanning system, a plurality of depth maps of a foot, the depth maps corresponding to different views of the foot;
generating, by a processor, a 3D model of the foot from the plurality of depth maps;
computing, by the processor, one or more measurements from the 3D model of the foot;
computing, by the processor, one or more shoe parameters based on the one or more measurements;
computing, by the processor, a shoe recommendation based on the one or more shoe parameters; and
outputting, by the processor, the shoe recommendation.

2. The method of claim 1, wherein the one or more measurements comprise a length of the foot, a width of the foot, and a height of an instep of foot.

3. The method of claim 1, wherein the one or more measurements comprise a measurement of a degree of pronation or supination of the foot.

4. The method of claim 1, wherein the shoe recommendation comprises a model and a size of a shoe.

5. The method of claim 1, wherein the shoe recommendation comprises a design for a component of a shoe, and
wherein the computing the one or more shoe parameters comprises computing parameters for the design of the component of the shoe based on the one or more measurements.

6. The method of claim 5, further comprising transmitting the design for the component of the shoe for fabrication.

7. The method of claim 6, wherein the fabrication is 3D printing.

8. The method of claim 5, wherein the component of the shoe is an outsole.

9. The method of claim 1, further comprising capturing, by the scanning system, a plurality of depth maps of a worn-out shoe, the depth maps corresponding to different views of the worn-out shoe;
generating, by the processor, a 3D model of the worn-out shoe from the plurality of depth maps; and
identifying, by the processor, wear patterns from the 3D model of the worn-out shoe,
wherein the computing the shoe recommendation is further based on the wear patterns from the 3D model of the worn-out shoe.

10. The method of claim 1, wherein the scanning system comprises:
a scanning sensor comprising a first two-dimensional (2D) camera having a first optical axis and a second 2D camera having a second optical axis substantially parallel to the first optical axis, the scanning sensor being configured to capture 2D images;
a display module separate from the scanning sensor and in communication with the scanning sensor; and
a host processor configured to control the scanning sensor and to display user feedback on the display module, the user feedback being based on the 2D images captured by the scanning sensor.

11. The method of claim 1, wherein the scanning system comprises:
an enclosure having a base;
a transparent platform in the enclosure, the transparent platform being parallel to the base;
a plurality of depth cameras in the enclosure, the depth cameras having fields of view directed toward the enclosure, each of the depth cameras comprising a plurality of 2D cameras; and
a central processing unit configured to control the depth cameras.

12. The method of claim 11, wherein the scanning system further comprises a plurality of color cameras.

13. The method of claim 11, wherein the depth cameras are registered to a common reference frame.

14. The method of claim 11, wherein the capturing the plurality of depth maps of the foot comprises capturing images while the foot is moving.

15. A system for generating shoe recommendations comprising:
a scanning system;
a processor coupled to the scanning system;
a memory coupled to the processor and having instructions stored therein that, when executed by the processor, cause the processor to:
control the scanning system to capture a plurality of depth maps of a foot, the depth maps corresponding to different views of the foot;
generate a 3D model of the foot from the plurality of depth maps;
compute one or more measurements from the 3D model of the foot;
compute one or more shoe parameters based on the one or more measurements;
compute a shoe recommendation based on the one or more shoe parameters; and
output the shoe recommendation.

16. The system of claim 15, wherein the one or more measurements comprise a length of the foot, a width of the foot, and a height of an instep of foot.

17. The system of claim 15, wherein the one or more measurements comprise a measurement of a degree of pronation or supination of the foot.

18. The system of claim 15, wherein the shoe recommendation comprises a model and a size of a shoe.

19. The system of claim 15, wherein the shoe recommendation comprises a design for a component of a shoe, and
wherein the instructions that cause the processor to compute the one or more shoe parameters further comprise instructions that cause the processor to compute parameters for the design of the component of the shoe based on the one or more measurements.

20. The system of claim 19, wherein the memory further stores instructions that, when executed by the processor, cause the processor to transmit the design for the component of the shoe for fabrication.

21. The system of claim 20, wherein the fabrication is 3D printing.

22. The system of claim 19, wherein the component of the shoe is an outsole.

23. The system of claim 15, wherein the memory further stores instructions that, when executed by the processor, cause the processor to:
control the scanning system to capture a plurality of depth maps of a worn-out shoe, the depth maps corresponding to different views of the worn-out shoe;
generate a 3D model of the worn-out shoe from the plurality of depth maps; and
identify wear patterns from the 3D model of the worn-out shoe,
wherein the memory further stores instructions that, when executed by the processor, cause the processor to compute the shoe recommendation further based on the wear patterns from the 3D model of the worn-out shoe.

24. The system of claim 15, wherein the scanning system comprises:
a scanning sensor comprising a first two-dimensional (2D) camera having a first optical axis and a second 2D camera having a second optical axis substantially parallel to the first optical axis, the scanning sensor being configured to capture 2D images;
a display module separate from the scanning sensor and in communication with the scanning sensor; and
a host processor configured to control the scanning sensor and to display user feedback on the display module, the user feedback being based on the 2D images captured by the scanning sensor.

25. The system of claim 15, wherein the scanning system comprises:
an enclosure having a base;
a transparent platform in the enclosure, the transparent platform being parallel to the base;
a plurality of depth cameras in the enclosure, the depth cameras having fields of view directed toward the enclosure, each of the depth cameras comprising a plurality of 2D cameras; and
a central processing unit configured to control the depth cameras.

26. The system of claim 25, wherein the scanning system further comprises a plurality of color cameras.

27. The system of claim 25, wherein the depth cameras are registered to a common reference frame.

28. The system of claim 25, wherein the instructions that, when executed by the processor, cause the processor to capture the plurality of depth maps of the foot further comprise instructions that, when executed by the processor, cause the processor to control the scanning system to capture images while the foot is moving.
